(19) United States
(12) Patent Application Publication
(10) Pub. No.: US 2015/0338635 A1
(43) Pub. Date: Nov. 26, 2015

(54) Mobile Optical Magnifier

(71) Applicant: Chris Gantz, Northbrook, IL (US)

(72) Inventor: Chris Gantz, Northbrook, IL (US)

(21) Appl. No.: 14/717,602

(22) Filed: May 20, 2015

Related U.S. Application Data
(60) Provisional application No. 62/000,644, filed on May 20, 2014.

(51) Int. Cl. G02B 25/00; H04M 1/02; H04M 1/725; G09G 3/20

(52) U.S. Cl. CPC G02B 25/002; G09G 3/20; H04M 1/027; H04M 1/7258; H04M 1/72527

(57) ABSTRACT

A mobile optical magnifier used for enlarging the viewing size of the display screen and amplifying the acoustical audio output of a mobile electronic device. The mobile optical magnifier comprises a wall structure that includes collapsible, interlinked bellows or foldable rigid walls, an optical magnifying lens, and a base plate. The optical lens is mounted on a first end of the wall structure and the base plate is mounted on a second end of the wall structure. At least one sidewall of the wall structure includes an aperture that enables the user to place a mobile electronic device on the base plate inside the mobile optical magnifier. The base plate also includes at least one independently hinged sound reflector that passively reflects the audio being generated by the mobile electronic device. The optical lens is covered by a hinged lens cover plate when not in use.

This application claims priority to provisional patent application Ser. No. 62/000,644, filed May 20, 2014, to the extent allowed by law.

### BACKGROUND OF THE INVENTION

### Field of the Invention

The present invention relates to a portable and mobile optical magnifier, and more particularly, to a standalone device designed for use as a portable and mobile optical magnifier that enlarges the viewing size of the display screen of a mobile electronic device.

### SUMMARY OF THE INVENTION

The mobile optical magnifier of the present invention comprises a wall structure that includes collapsible, interlinked bellows or foldable rigid walls, an optical lens, and a base plate. The optical lens is a magnifying lens mounted on a first end of the bellows and the base plate is mounted on a second end of the bellows. At least one sidewall of the bellows includes an aperture that enables the user to place a mobile electronic device inside the mobile optical magnifier and place the mobile electronic device on the base plate. The base plate also includes at least one independently hinged sound reflector that passively reflects the audio being generated by the mobile electronic device towards the user. The optical magnifying lens is covered by a hinged lens cover plate when not in use.

It is a primary object of the present invention to provide a mobile optical magnifier that enlarges the viewing size of the display screen of the mobile electronic device, while maintaining privacy when viewing in public spaces.

Another object of the present invention is to provide a mobile optical magnifier that allows the user to view the display screen of the mobile electronic device even in the brightest ambient light.

Still another object of the present invention is to provide a mobile optical magnifier that allows multiple users to comfortably view the display screen of the mobile electronic device at the same time.

Still another object of the present invention is to provide a mobile optical magnifier that redirects the acoustic sound pressure being generated by the mobile electronic device, located within the device, towards the user, located external to the mobile optical display.

Still another object of the present invention is to provide a mobile optical magnifier that moderately amplifies the audio generated by the mobile electronic device, by electronic or powered means or any other amplifying means known in the art.

Still another object of the present invention is to provide a mobile optical magnifier that allows for the upright positioning of the viewing area at an optimal optical user viewing height, and allows for the adjustment of that height.

### BRIEF DESCRIPTION OF THE DRAWINGS

The present invention is further described with reference to the accompanying drawings in which:

FIG. 1 is a front-first side perspective view of a first embodiment, in use, of the mobile optical magnifier of the present invention.

FIG. 2 is a front-second side perspective view of the first embodiment of the mobile optical magnifier of the present invention;

FIG. 3 is a front-first side perspective view of the first embodiment of the mobile optical magnifier of the present invention;

FIG. 4 is a front-first side perspective view of the first embodiment of the mobile optical magnifier of the present invention, showing the bellows structure and the aperture in the bellows or insertion and removal of the mobile electronic device;

FIG. 5 is a side view of the first embodiment of the mobile optical magnifier of the present invention, showing the mobile electronic device inserted into the aperture of the bellows;

FIG. 6 is a top schematic cross-sectional view of the first embodiment of the mobile optical magnifier of the present invention, taken along line VI-VI of FIG. 5;

FIG. 7 is a top plan view of the first embodiment of the mobile optical magnifier of the present invention;

FIG. 8 is a top perspective view of the first embodiment of the mobile optical magnifier of the present invention;

FIG. 9 is a rear perspective view of the first embodiment of the mobile optical magnifier of the present invention;

FIG. 10 is a rear perspective detail view of the first embodiment of the mobile optical magnifier of the present invention, showing the sound reflectors in their closed position;

FIG. 11 is a side cross-sectional view of the first embodiment of the mobile optical magnifier of the present invention, taken along line XI-XI in FIG. 9;

FIG. 12 is a detail cross-sectional perspective view of the optical lens attachment assembly of the first embodiment of the mobile optical magnifier of the present invention;

FIG. 13 is another detail cross-sectional perspective view of the optical lens of the first embodiment of the mobile optical magnifier of the present invention;

FIG. 14 is a rear perspective view of the first embodiment, collapsed and not in use, of the mobile optical magnifier of the present invention, with a holding strap engaged;

FIG. 15 is a rear perspective view of the first embodiment of the mobile optical magnifier of the present invention, with a holding strap disengaged;

FIG. 16 is a front perspective view of the first embodiment, collapsed and not in use, of the mobile optical magnifier of the present invention;

FIG. 17 is a rear-side perspective view of the first embodiment, collapsed and not in use, of the mobile optical magnifier of the present invention, with the sound reflectors not shown;

FIG. 18 is another rear perspective view of the first embodiment, collapsed and not in use, of the mobile optical magnifier of the present invention, with the sound reflectors not shown;

FIG. 19 is a rear perspective view of the first embodiment, collapsed and not in use, of the mobile optical magnifier of the present invention, showing the sound reflectors when not in use;

FIG. 20 is a detail cross-sectional view of the bellows structure of the first embodiment, collapsed and not in use, of the mobile optical magnifier of the present invention;

FIG. 21 is a cross-sectional view of the first embodiment, collapsed and not in use, of the mobile optical magnifier of the present invention, taken along line XXI-XXI of FIG. 19;

FIG. 22 is a detail cross-sectional view of the first embodiment, collapsed and not in use, of the mobile optical magnifier of the present invention, with the mobile electronic device on the base plate;

FIG. 23 is a detail, exploded view of the hinge assembly of the embodiment of the mobile optical magnifier of the present invention, which hinge assembly is used to removably and pivotally attach several elements of the invention to the bellows frame;

FIG. 24 is a front-first side perspective view of a second embodiment of the mobile optical magnifier of the present invention;

FIG. 25 is a front-top perspective view of the second embodiment of the mobile optical magnifier of the present invention;

FIG. 26 a, b, and c are a front perspective view of a fourth embodiment of the mobile optical magnifier the present invention.

FIG. 27 is a front-side perspective view of the fourth embodiment of the mobile optical magnifier of the present invention;

FIG. 28 is a side plan view of the fourth embodiment of the mobile optical magnifier of the present invention;

FIG. 29 is a front-side perspective view of a fifth embodiment of the mobile optical magnifier of the present invention; and

FIG. 30 is a front perspective view of the fifth embodiment, when not in use, of the mobile optical magnifier of the present invention.

### DETAILED DESCRIPTION OF THE ILLUSTRATED EMBODIMENTS

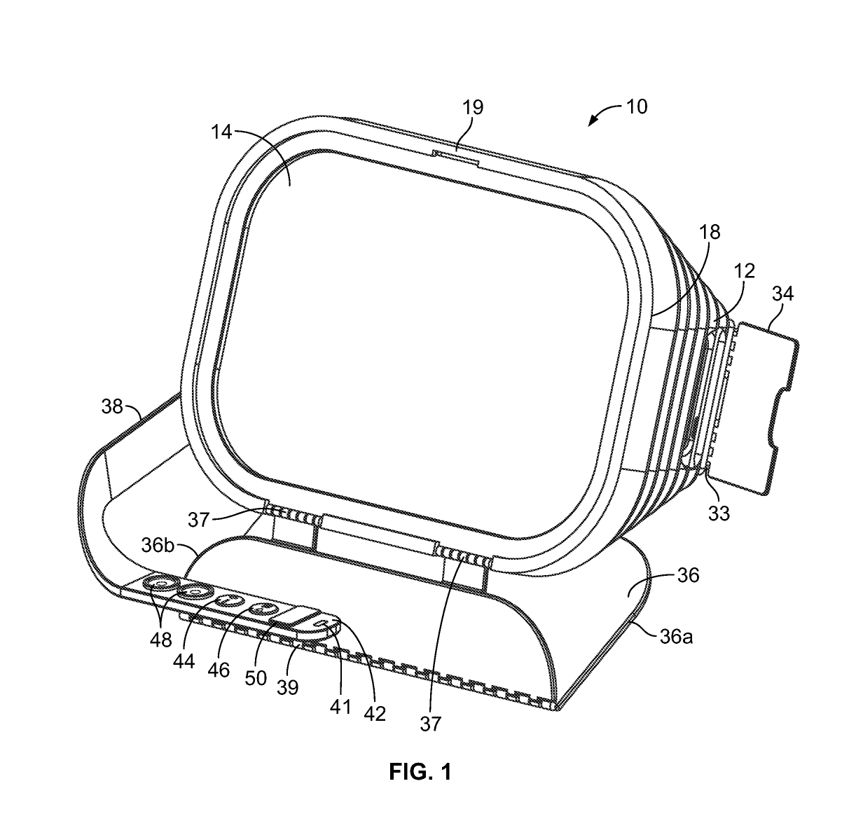

The mobile optical magnifier of the present invention is a standalone device designed for use as a portable and mobile magnifier for enlarging the viewing size of the image on the display screen of a mobile electronic device. The video display of the mobile electronic device is enlarged and displayed on the mobile optical magnifying lens, shown in a first embodiment in FIG. 1. The mobile optical magnifier also redirects and/or amplifies the acoustical audio output of the mobile electronic device toward the user.

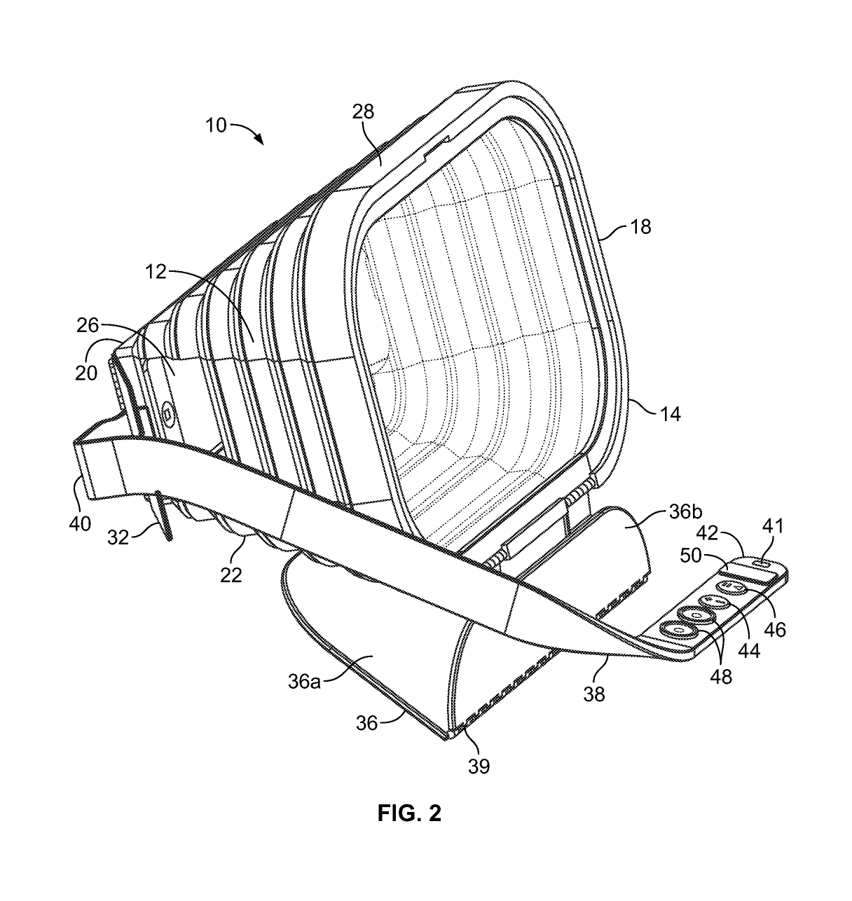

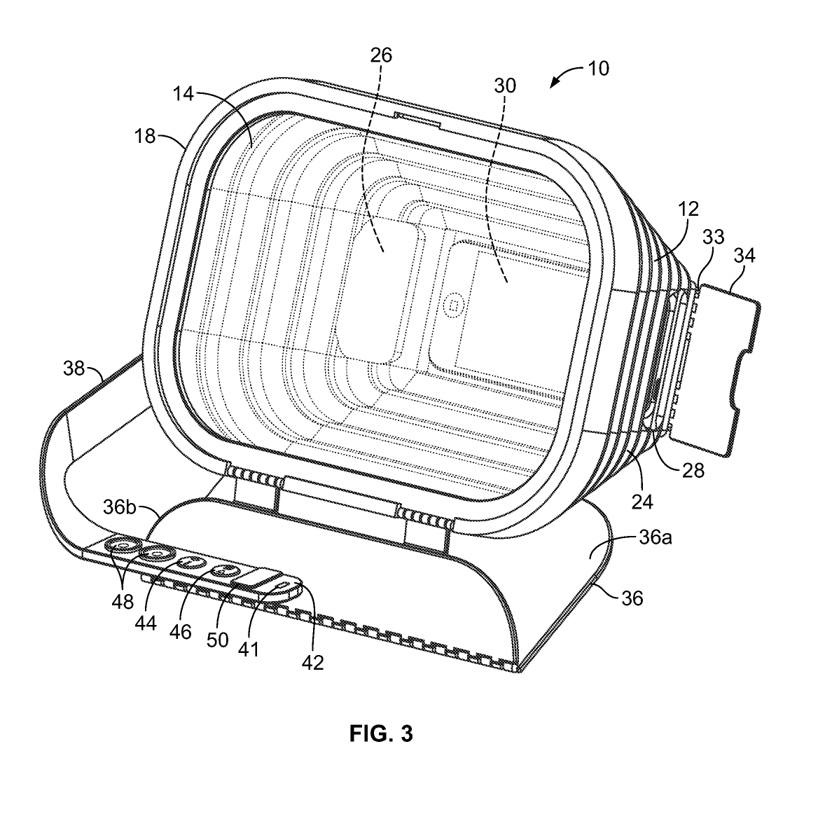

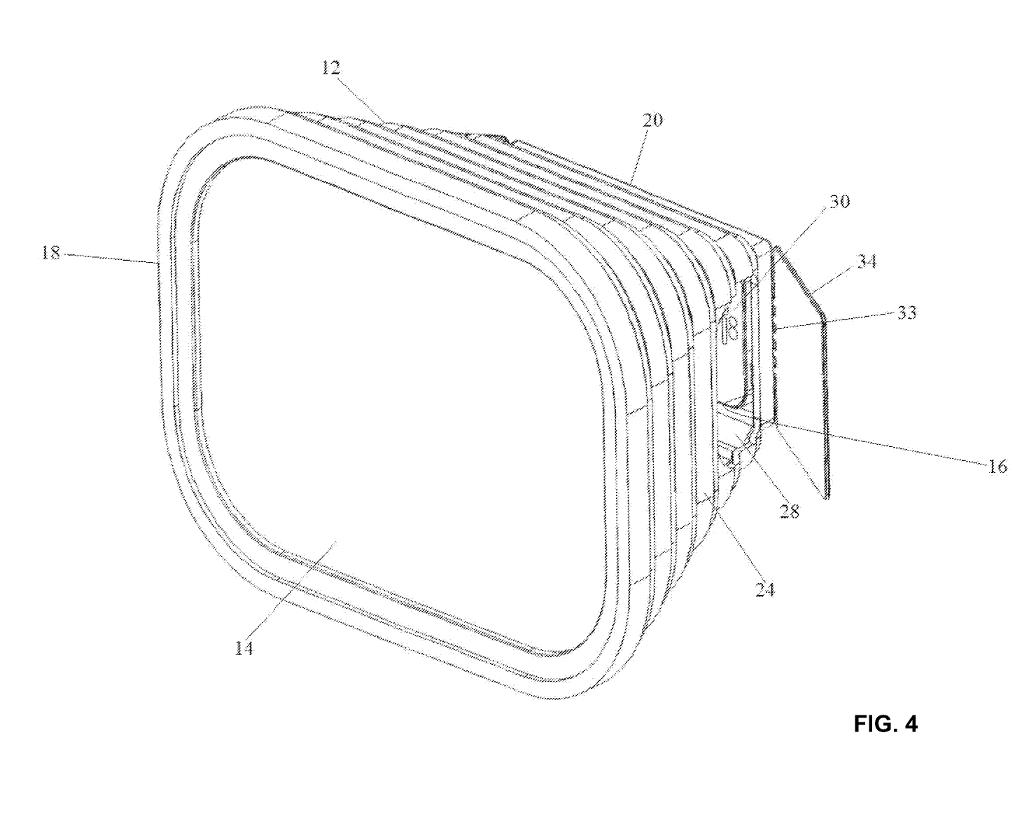

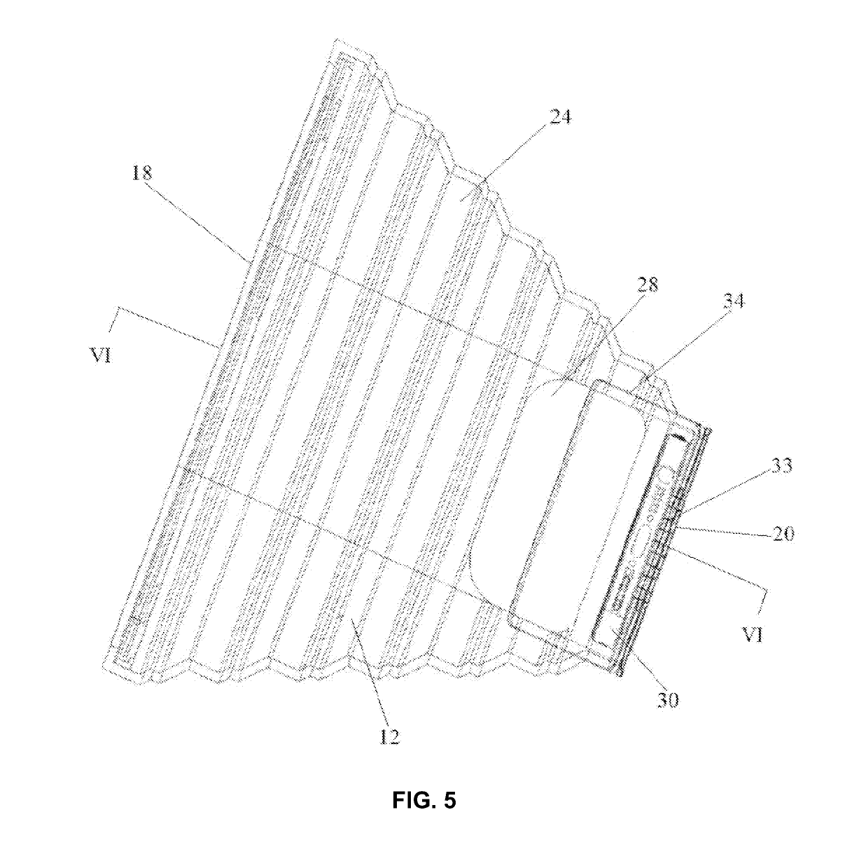

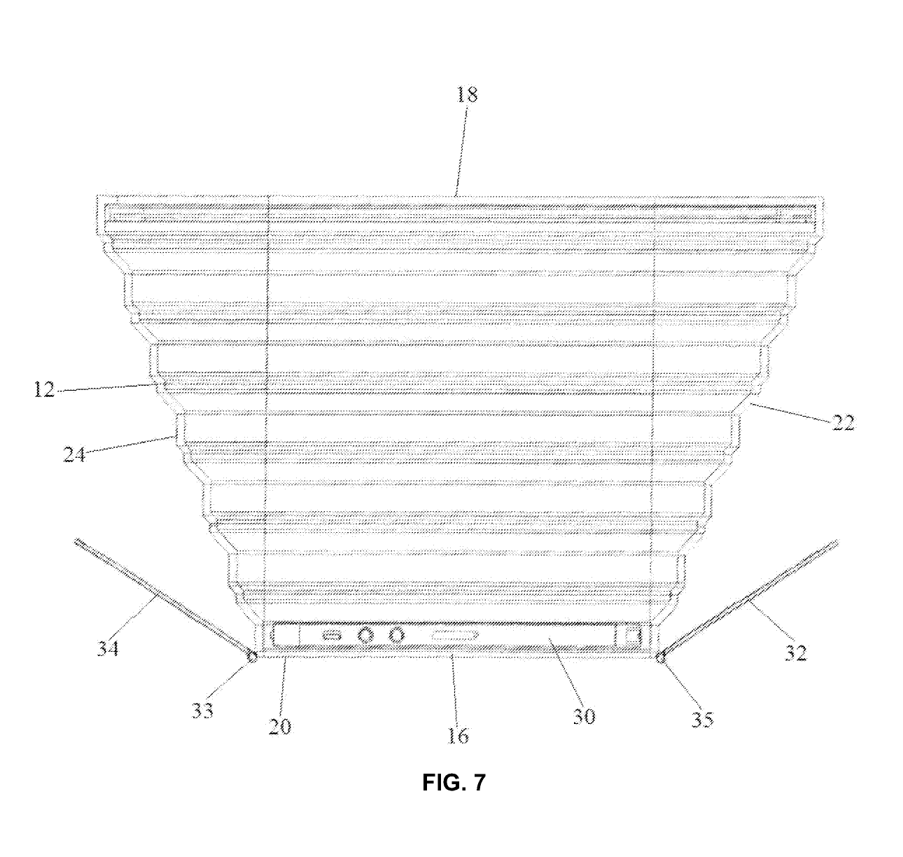

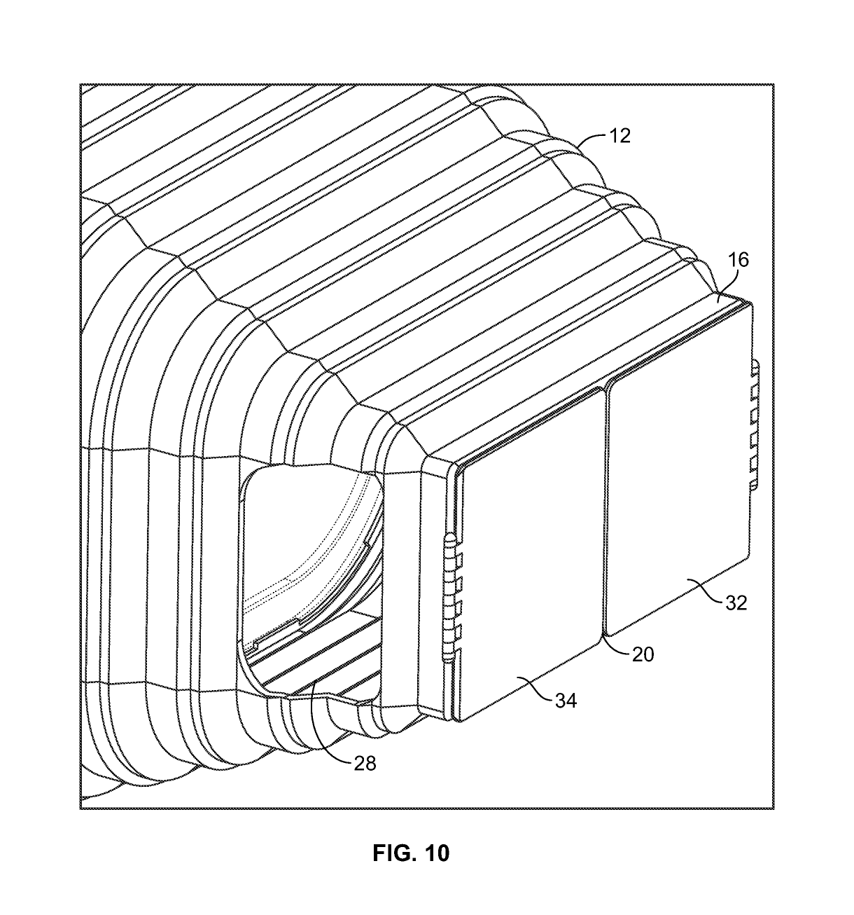

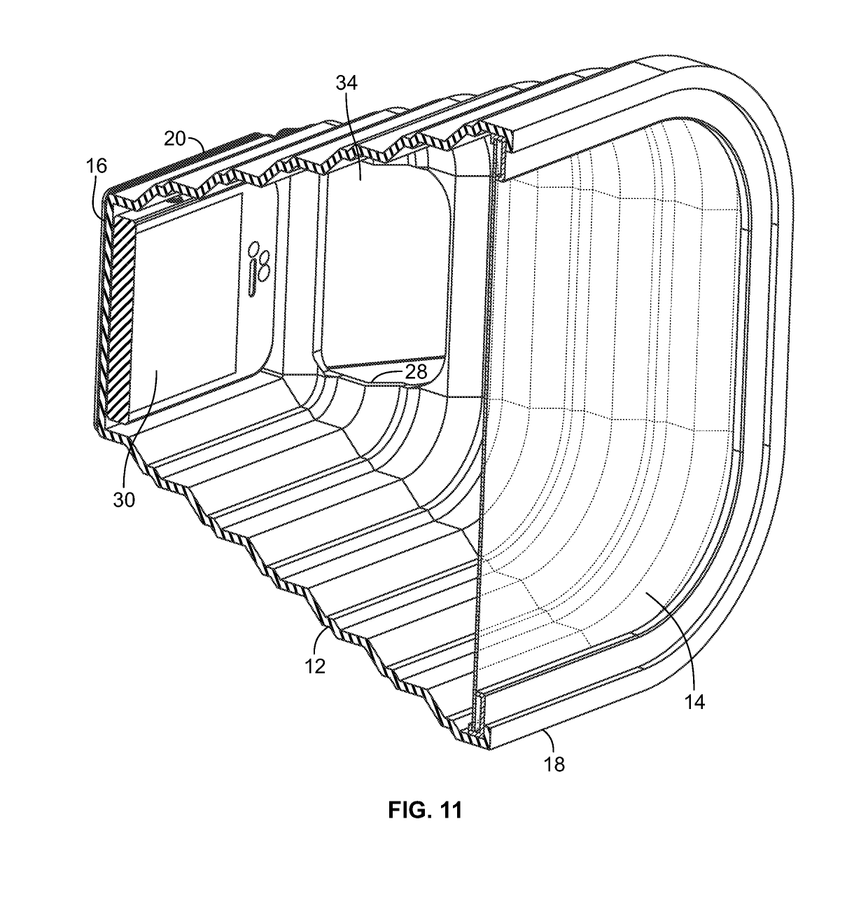

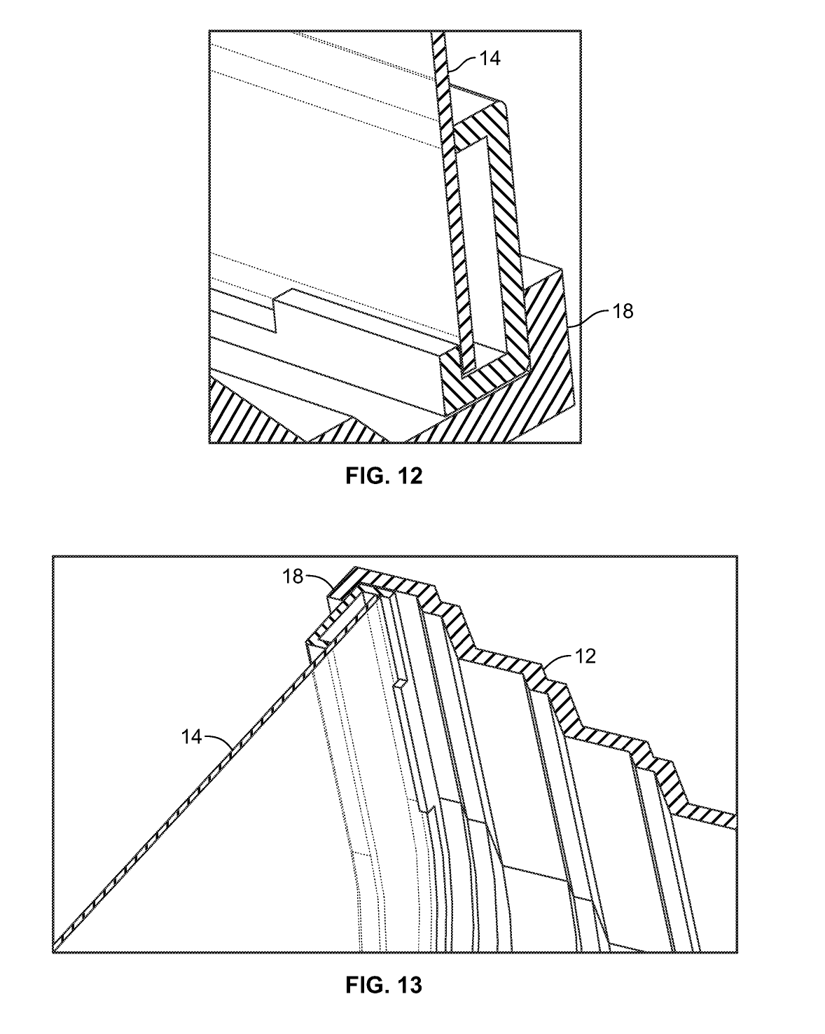

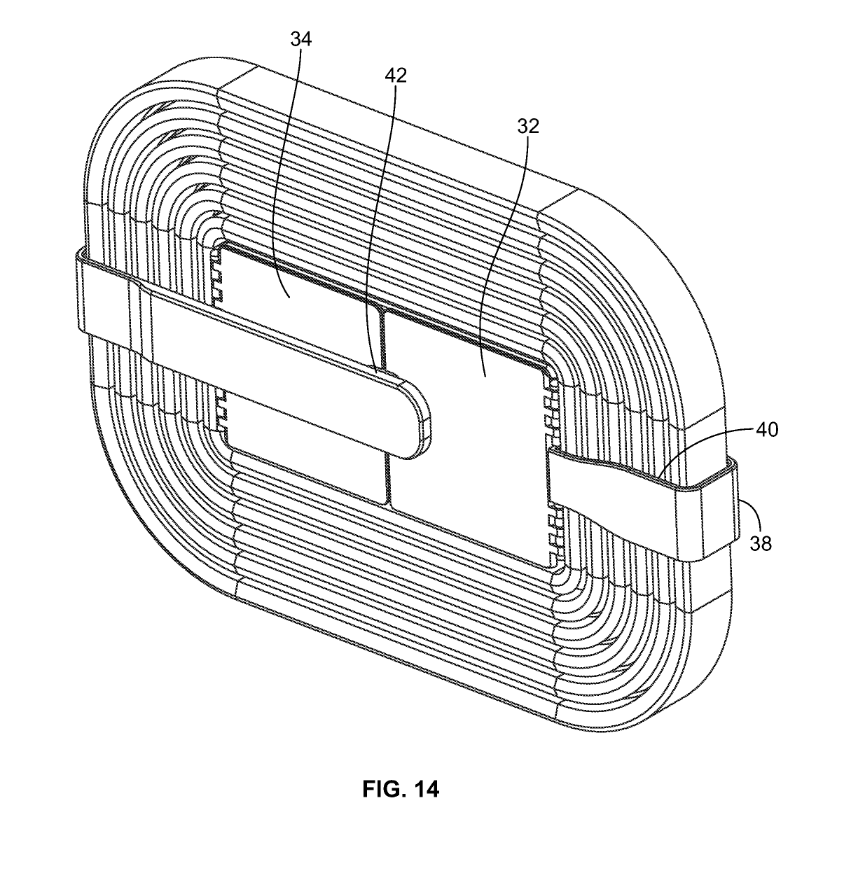

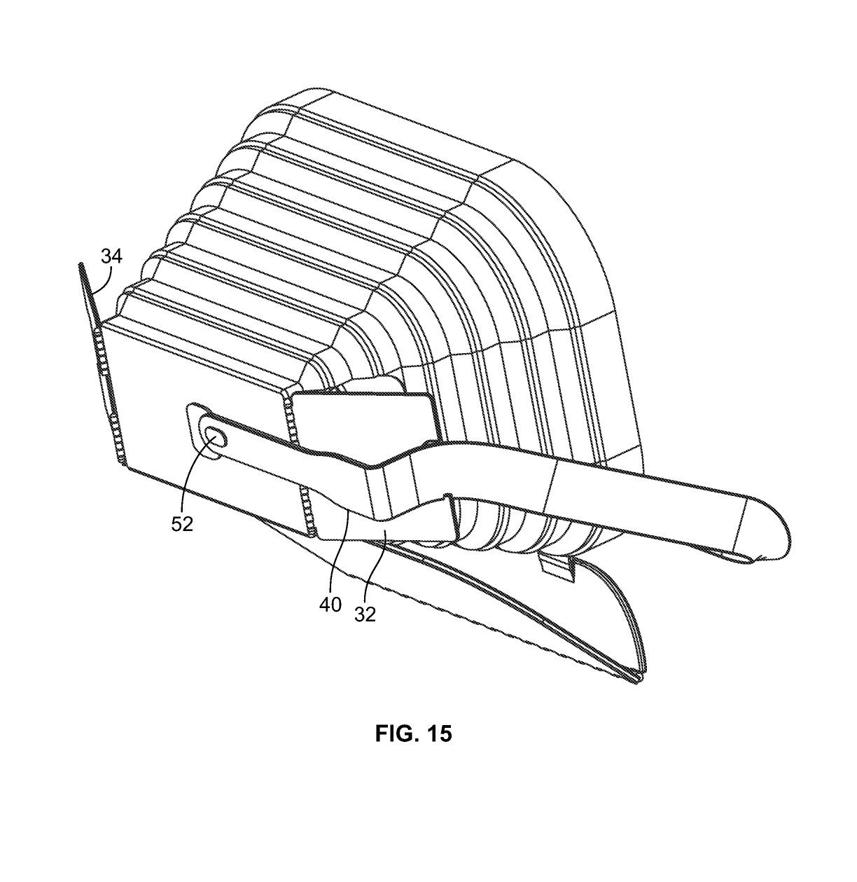

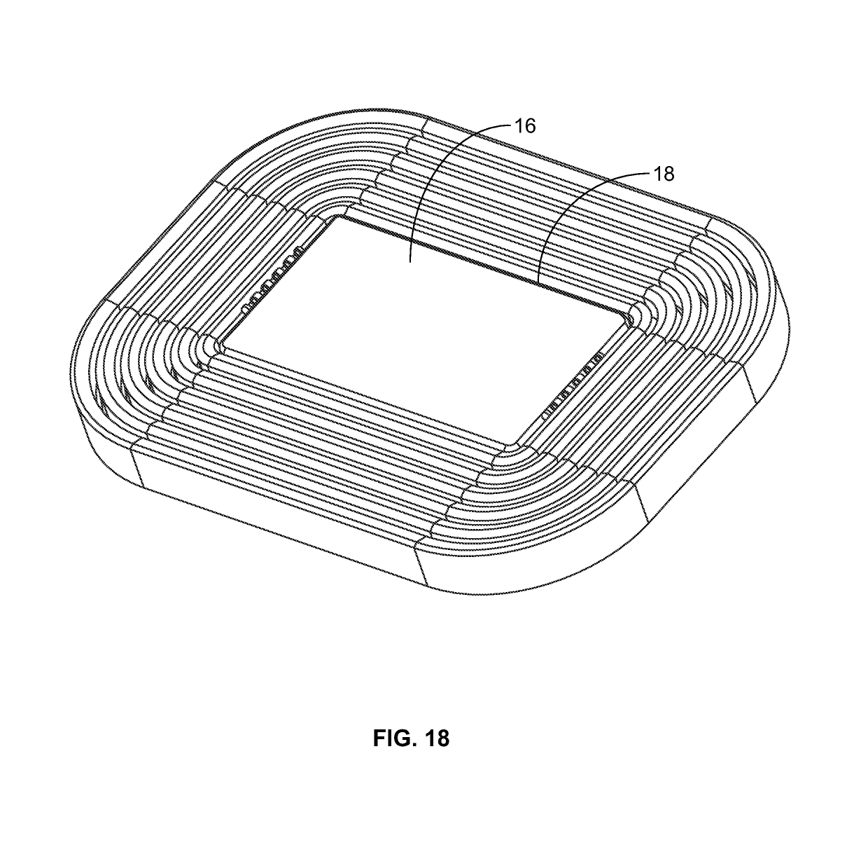

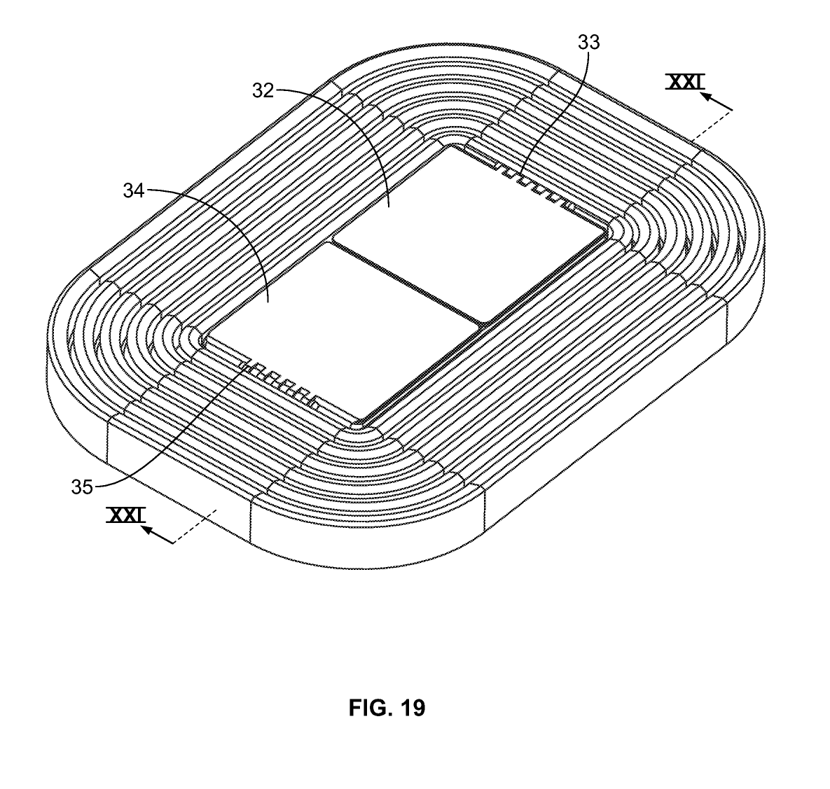

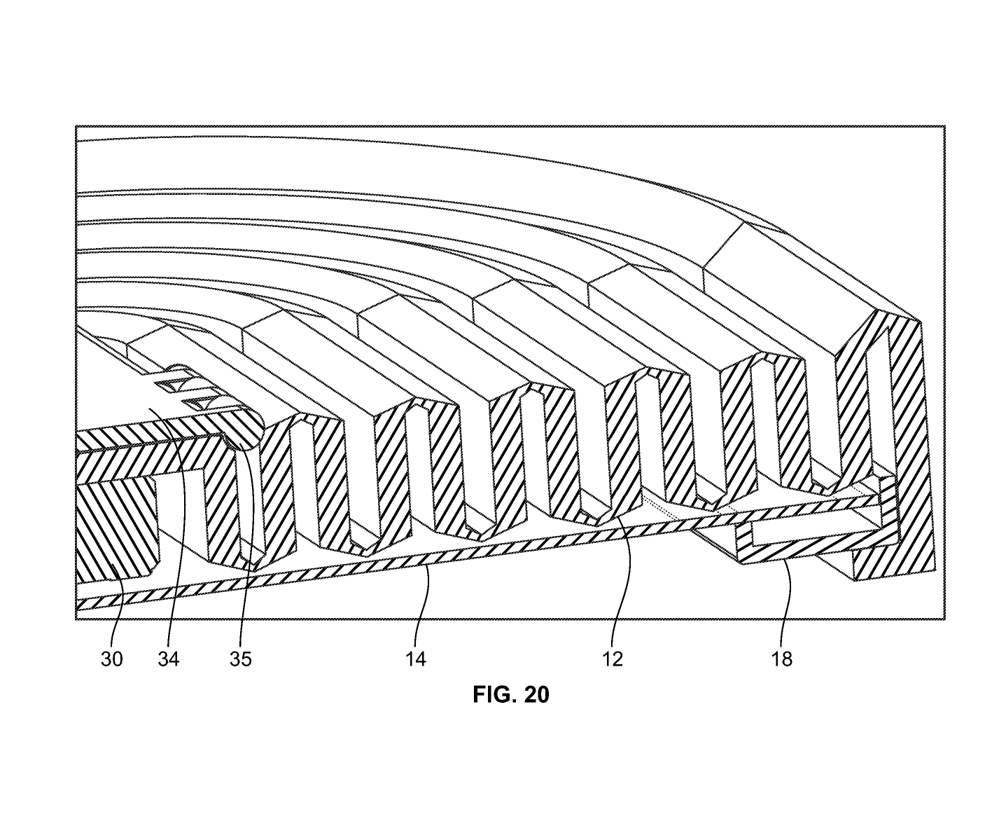

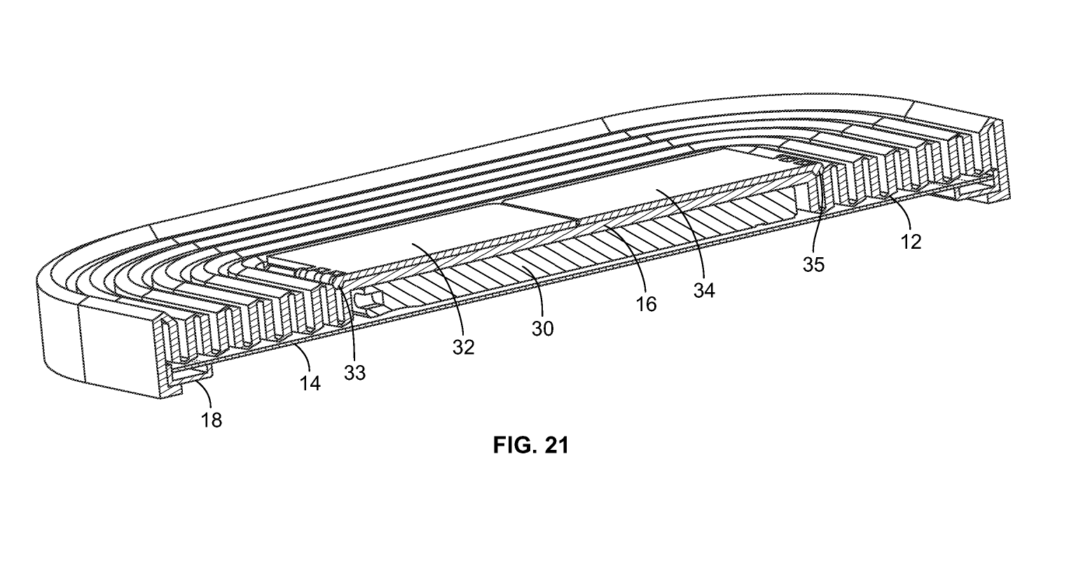

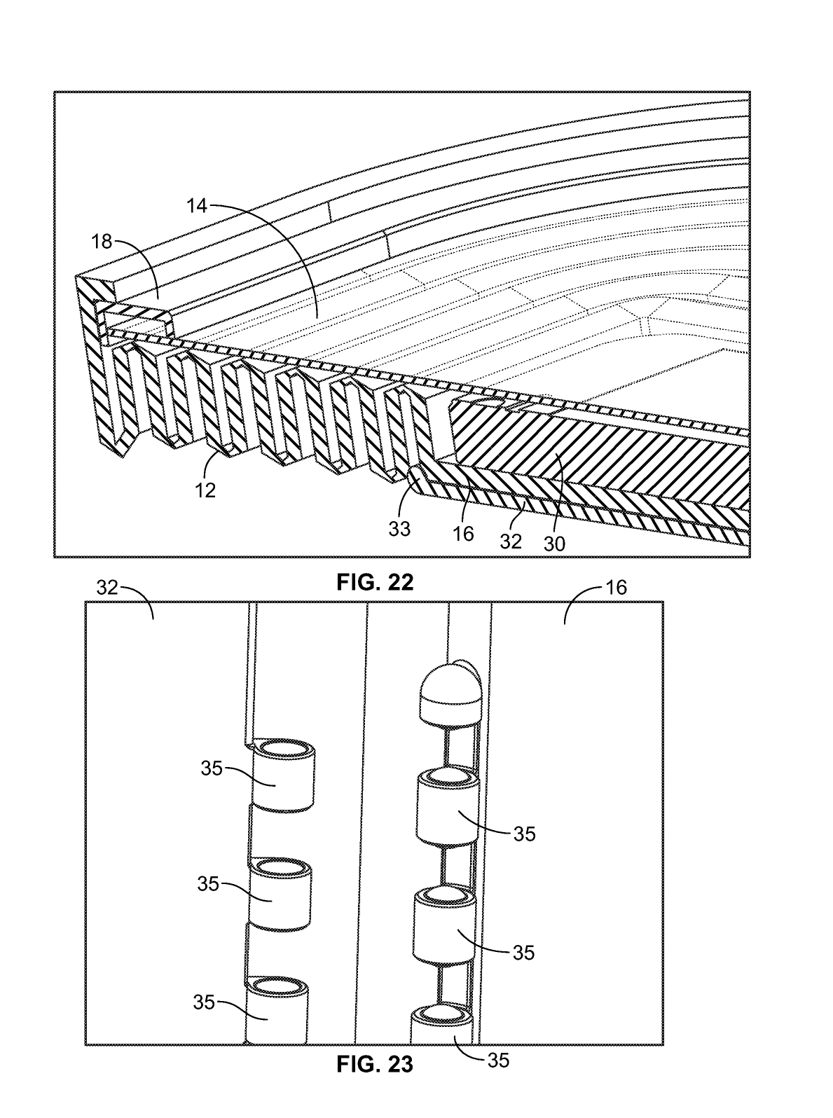

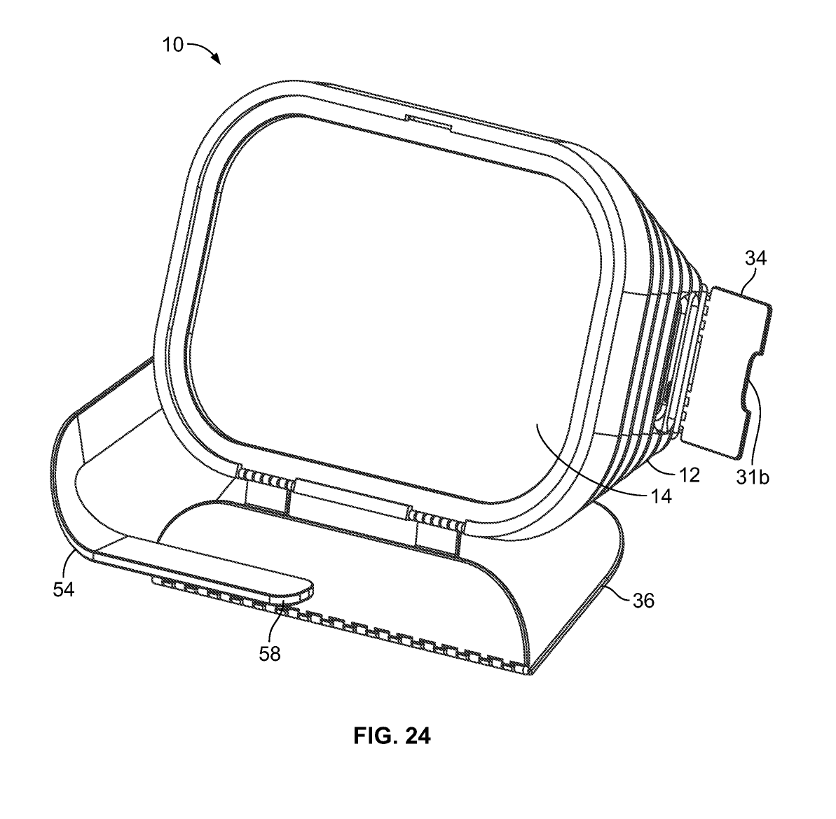

The mobile optical magnifier 10 of the present invention, in a first illustrated embodiment shown in an open position in FIGS. 1-13 and in a collapsed position in FIGS. 14-23, comprises flexible bellows 12, an optical magnifying lens 14 and a base plate 16 (FIG. 4). The optical magnifying lens 14 is mounted on a first end 18 of the bellows 12 and the base plate 16 is mounted in a frame 19 mounted on a second end 20 of the bellows 12, the second end 20 located opposite the first end 18. The bellows 12 supporting the optical magnifying lens 14 and base plate 16 is flexible and collapses for storage when not in use. When in use, the bellows 12 extends to provide the exact placement of the optical magnifying lens 14 at a fixed distance from the base plate 16. When not in use, applying gentle pressure to both the optical magnifying lens 14 and the base plate 16 will cause flexible the bellows 12 to collapse into a small flat package to facilitate storage and mobility.

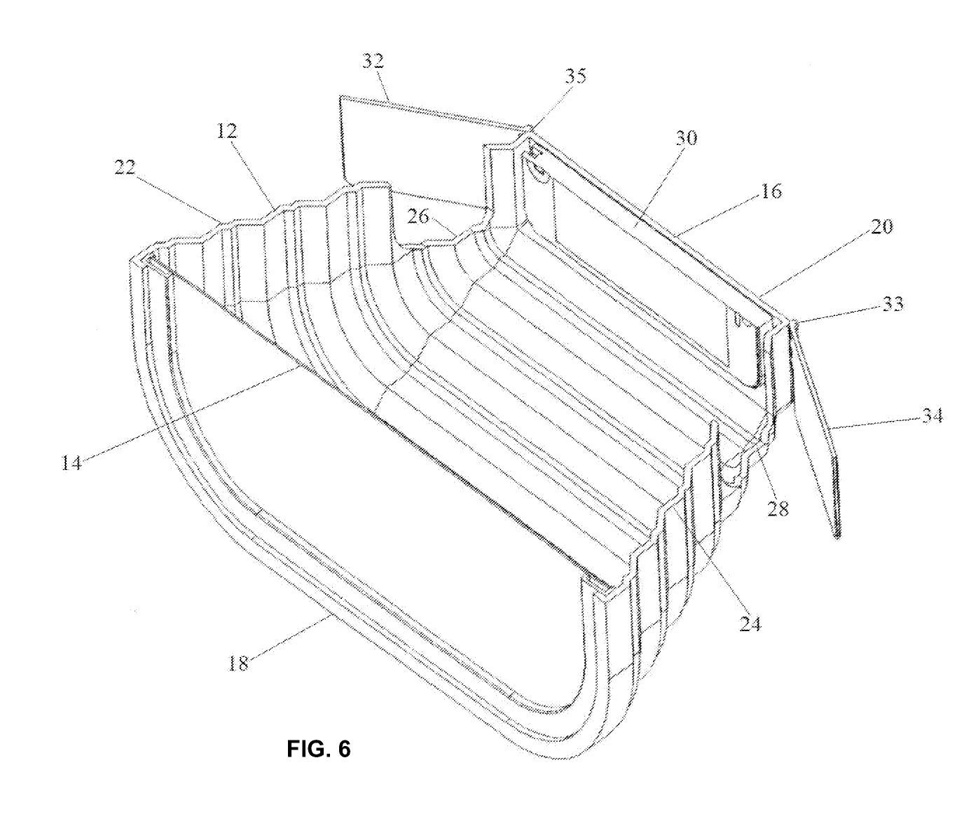

The bellows 12 also includes opposing walls 22, 24 (FIG. 6), where at least one sidewall 22, 24 includes an aperture 26, 28 that becomes visible and user accessible when the bellows 12 have been expanded and are fully extended. The apertures 26, 28 allow the user to place a mobile electronic device 30 on the base plate 16 inside the mobile optical magnifier 10. The base plate 16 provides for the upright positioning of the mobile electronic device 30 and provides optimal optical user viewing of the display screen of the mobile electronic device 30 through the optical magnifying optical magnifying lens 14 mounted in frame 19 on the first end 18 of the mobile optical magnifier 10.

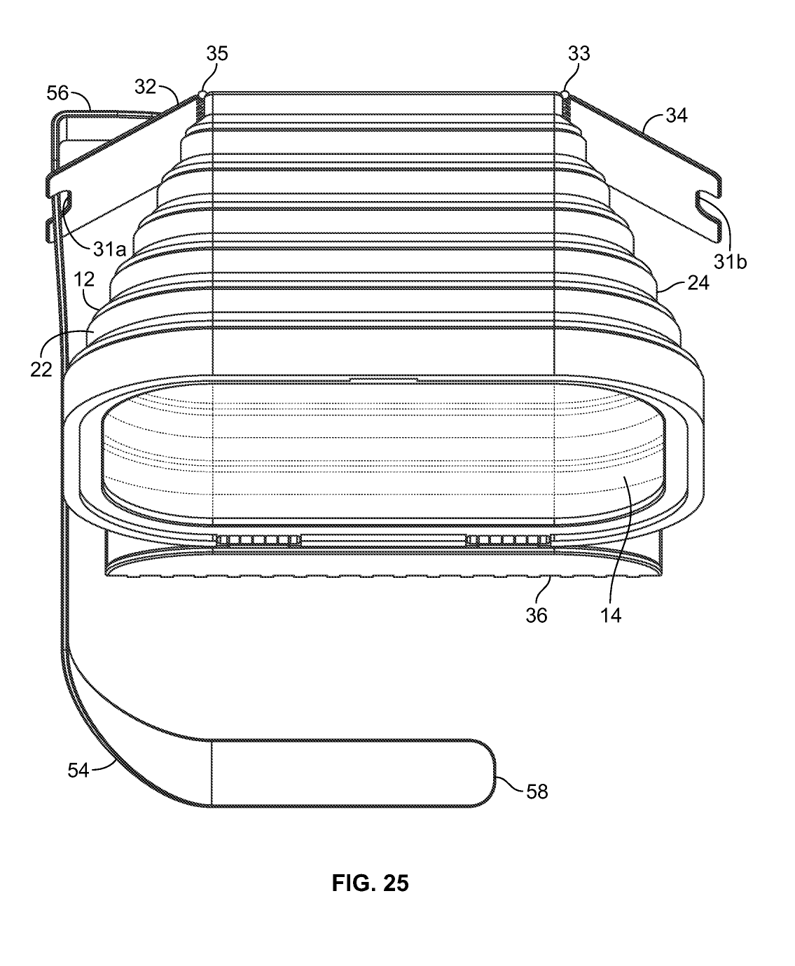

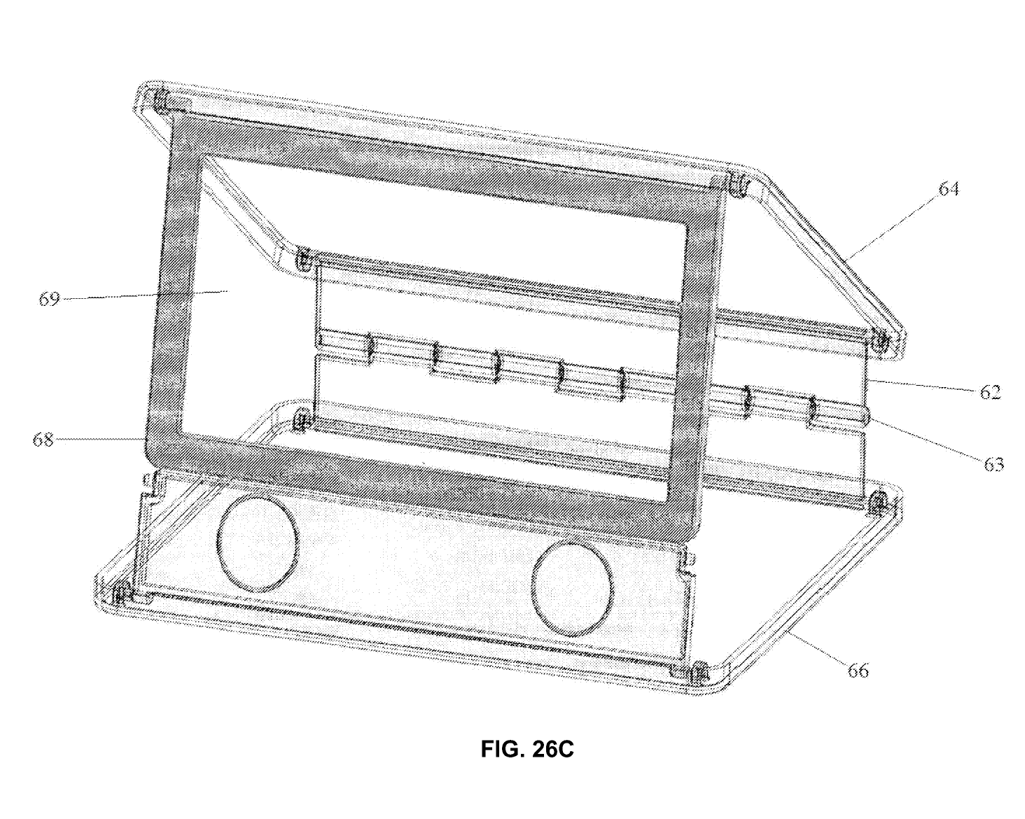

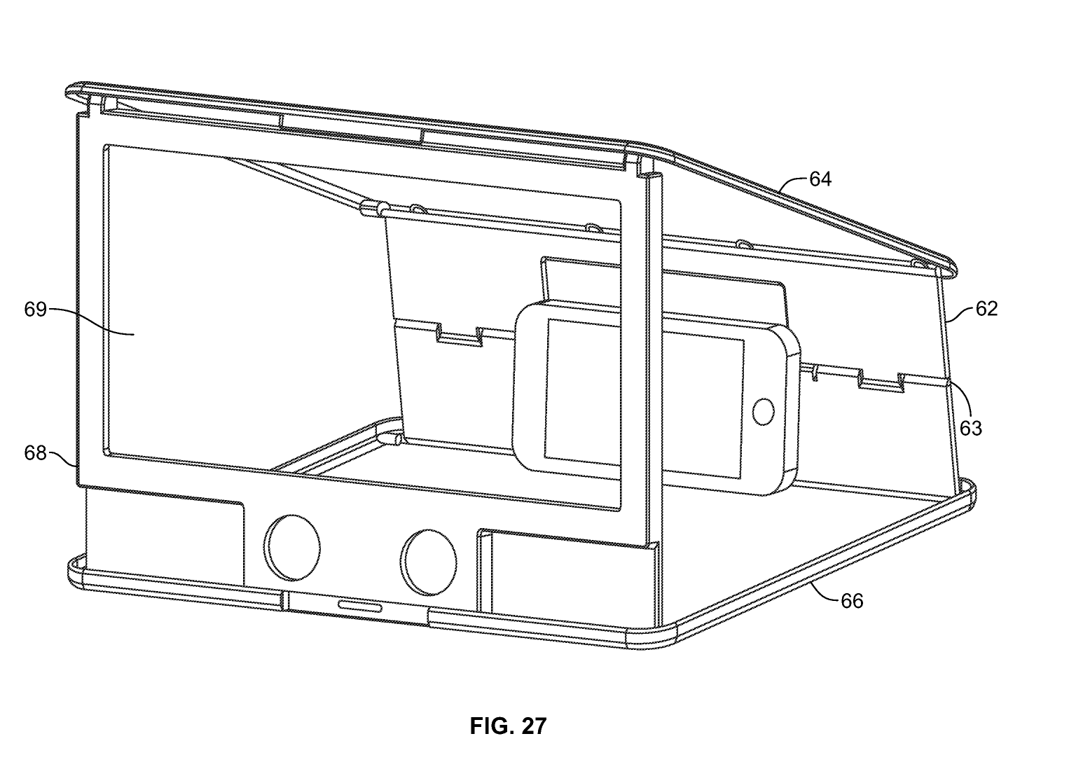

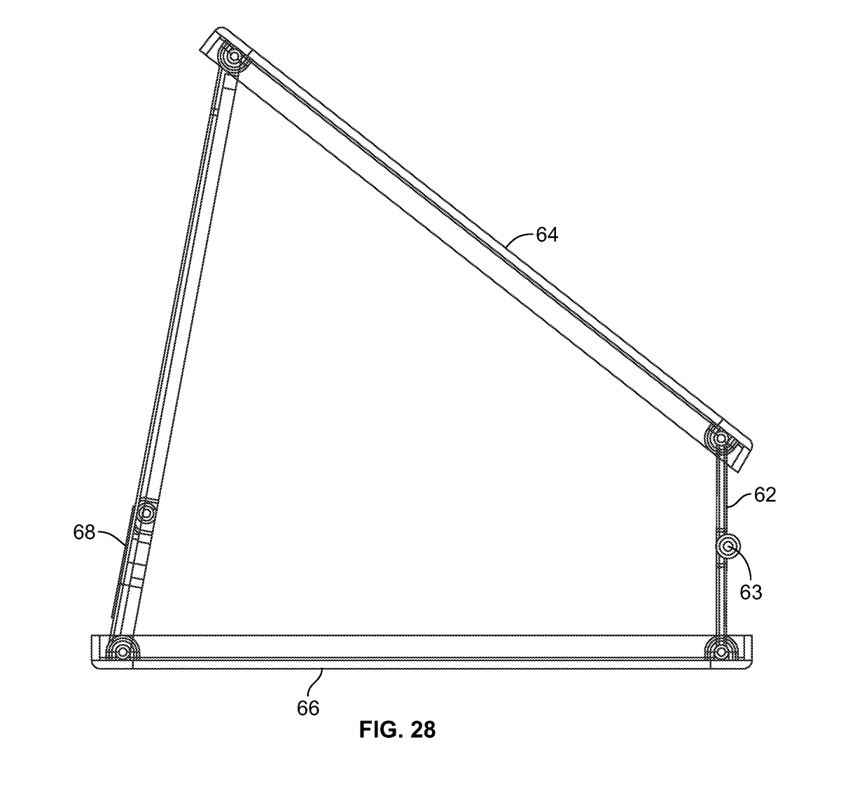

The mobile optical magnifier 10 includes at least one independently hinged sound reflector 32, 34 that can be rotated from a stored flat position on the back of the base plate 16 to a forward facing position, as shown in FIG. 6. The sound reflectors 32, 34 have hinges 33, 35 that are engaged with hinges 17 on base plate 16 (FIG. 23). In the forward facing position, the sound reflectors 32, 34 passively redirect and moderately amplify the audio output generated from the mobile electronic device 30 toward the first end 18 of the mobile optical magnifier 10. The at least one independently hinged sound reflector can also be implemented in the embodiments shown in FIGS. 26a, 26b, 26c, and 27-30.

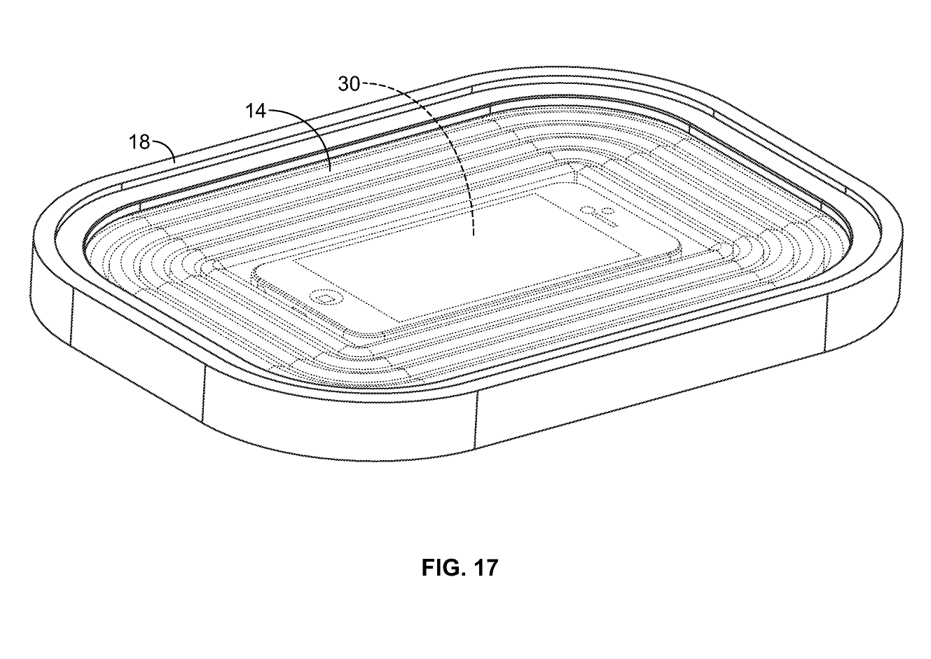

When the mobile optical magnifier 10 is not in use, the optical magnifying lens 14 is covered and protected by a hinged lens cover plate 36 (FIG. 16). The hinged cover plate 36 is pivotally connected to frame 19 by hinges 37. A lateral hinge 39 also pivotally connects section 36a to section 36b of cover plate 36. When in use, the hinged lens cover plate 36 is folded away from the optical magnifying lens 14, as seen in FIGS. 1-3, to permit viewing through the optical magnifying lens 14. The hinged lens cover plate 36 also functions as a viewing height adjustor. When the mobile optical magnifier 10 is open and in use on any flat surface, the hinged lens cover plate 36 folds away from the optical magnifying lens 14 and can be manually adjusted by the user to raise or lower the viewing optical magnifying lens 14. The optical lens in the embodiments shown in FIGS. 26a, 26b, 26c, and 27-30 can also be covered and protected by a hinged lens cover plate as described in this embodiment.

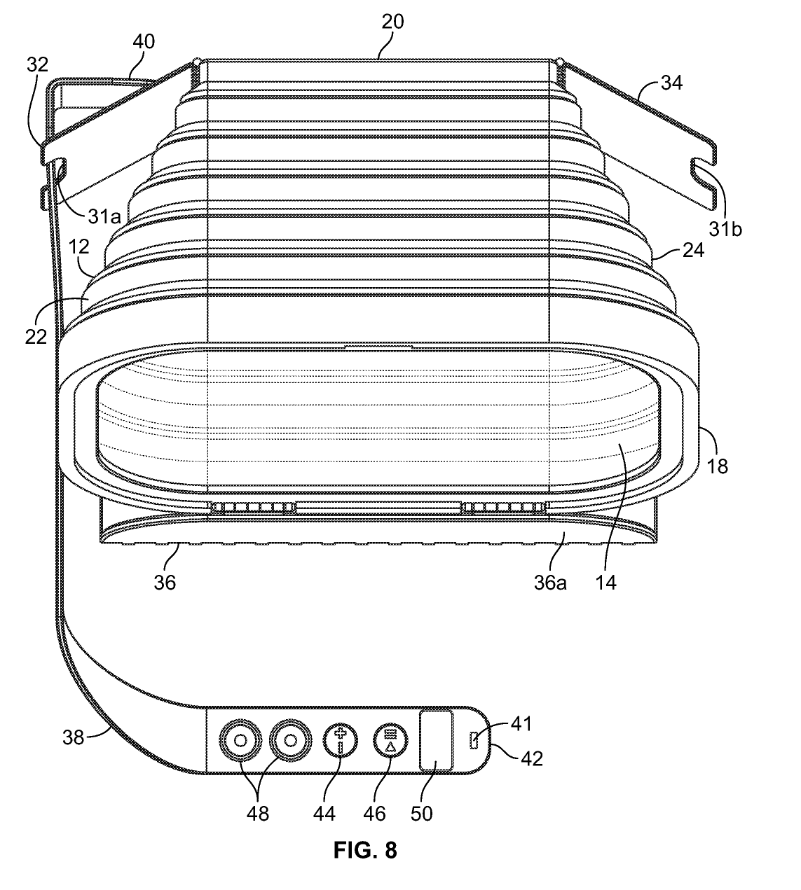

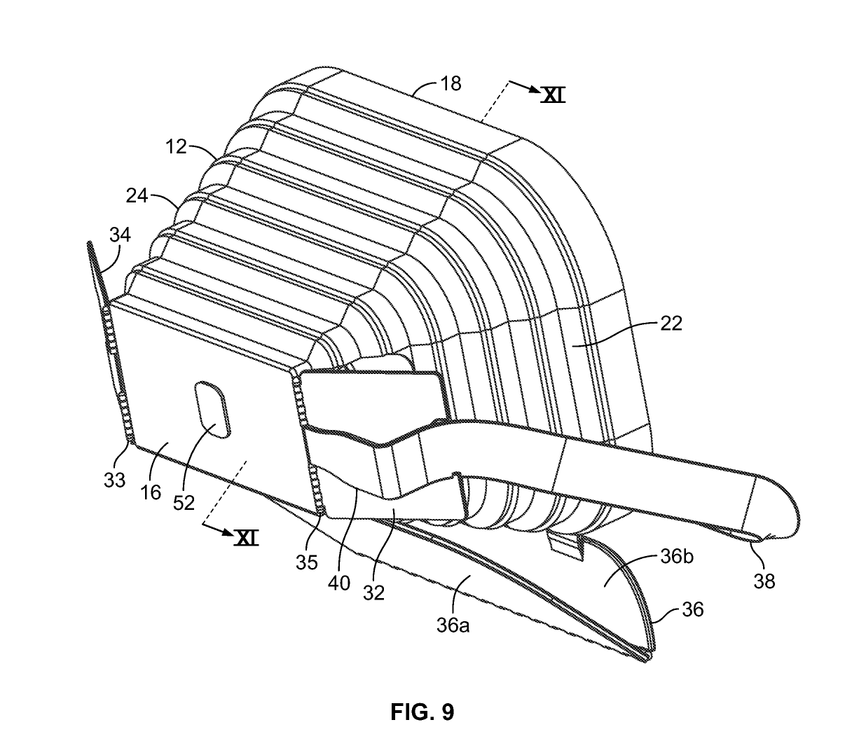

In the first embodiment of the present invention, the mobile optical magnifier 10 includes an active flexible cable 38, shown in FIGS. 8 and 9, that comprises passive and/or powered components and control switches that allow the user to control the audio and video of the mobile electronic device 30. The active cable 38 interfaces with the mobile electronic device 30 and provides control of an external audio speaker (not shown) and a microphone 41. The active cable 38 includes two or three audio components mounted within the physical cable. The first component is one or two speakers and the second component is a microphone that can be used when using the installed mobile electronic device 30 in phone mode. All audio is routed from the mobile electronic device 30 to the external speakers and microphone 41 whenever the active cable 38 is engaged with the mobile electronic device 30.

A first end 40, shown in FIG. 9, of the active cable 38 attaches to hinge 35 of sound reflector 32 and includes a standard 3.5 mm 4 pole plug that is inserted into the audio jack of the mobile electronic device 30. Alternatively, the active cable can include a plug (not shown) that engages the data port in the mobile electronic device 30. Both the speakers and the microphone connect to the mobile electronic device 30 via the 3.5 mm plug on the first end of active cable 38. A second end 42 of the active cable 38 includes a panel of control switches. The control switches are at least one of an audio control switch 44, a video control switch 46, and a call handling switch 48. The audio control switch 44 allows the user to raise and lower the audio output level of the mobile electronic device 30. The video control switch 46 allows the user to pause, fast forward, rewind, and play the video. The call handling control switch 48 allows the user to generate a call, answer a call, and end a call. Alternatively, the functions of the switches can change based on the mode the mobile electronic device 30 is in. When the mobile electronic device 30 is displaying a video or playing audio, the control switches control play, pause, rewind, and fast forward. When the mobile electronic device 30 is not playing video, the control switches control call handling.

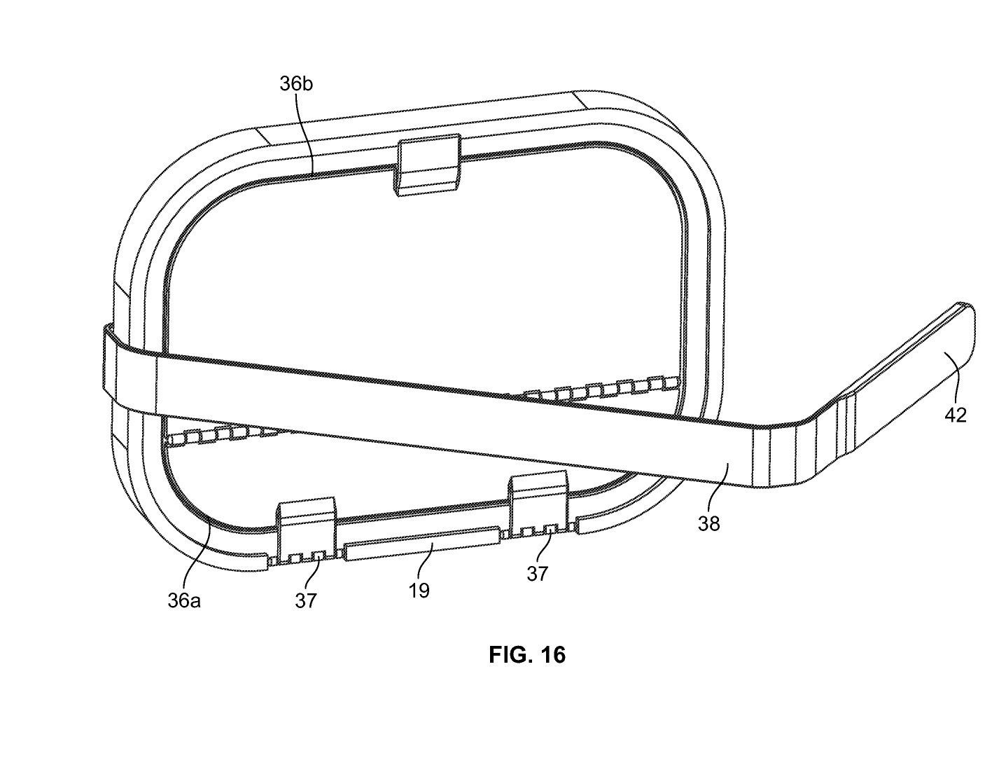

The second end 42 also includes a hook and loop fastener element 50 that engages a hook and loop fastener element 52 on the outer backside of the active cable 38 (FIG. 15). To store the device 10 when not in use, the sound reflectors 32, 34 are closed onto the base plate 16 and the active cable 38 is passed through notches 31a and 31b, shown in FIG. 8, in sound reflectors 32, 34. The active cable 38 is then wrapped around the mobile optical magnifier 10 and secured in place by engaging hook and loop fastener 50 with hook and loop fastener 52 when not in use (FIG. 14), ensuring that the magnifier 10 remains compact and occupies the minimum amount of space for storage and mobility. The active cable described in this embodiment can also be implemented in the embodiments shown in FIGS. 26a, 26b, 26c, and 27-30.

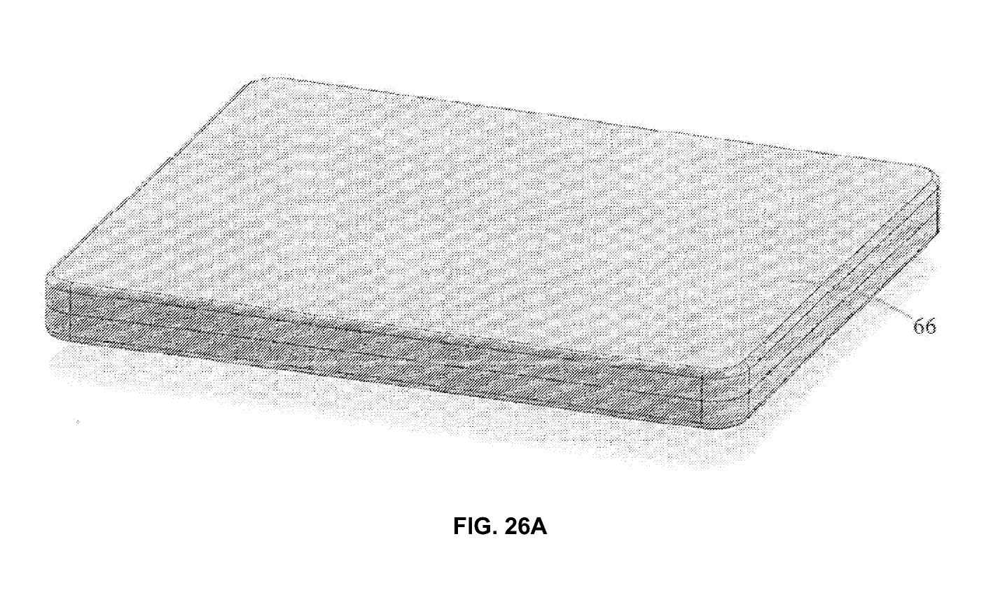

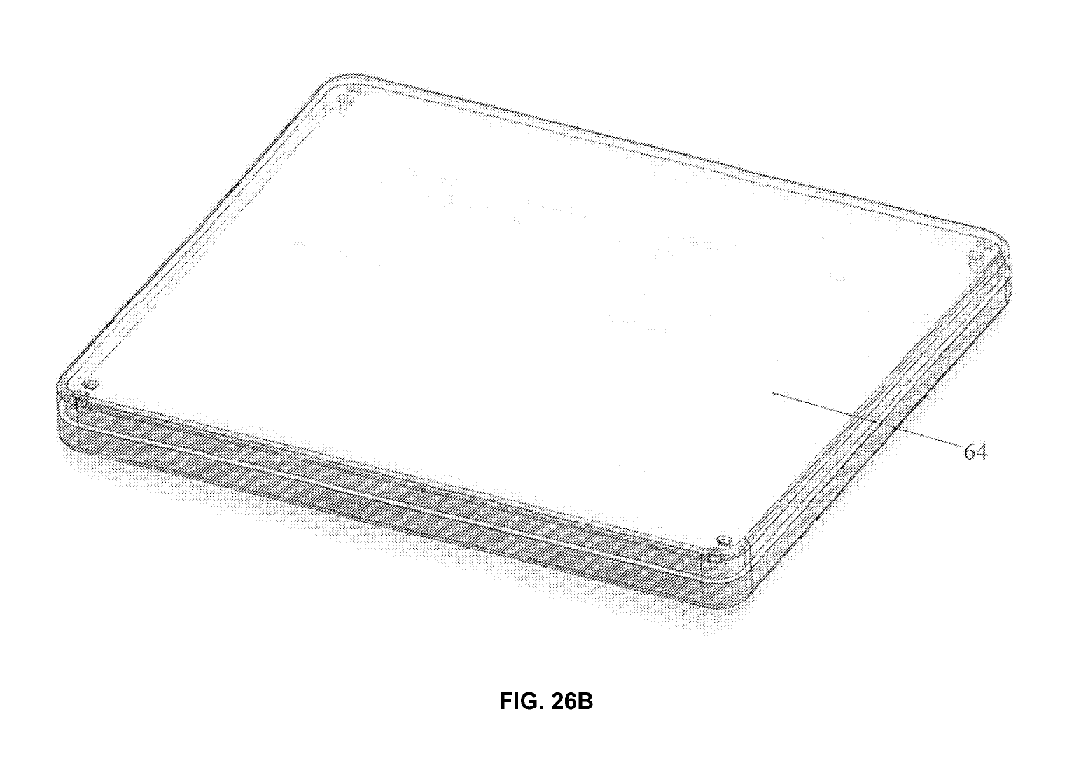

In a second embodiment of the present invention, the mobile optical magnifier 10 includes a retainer cable 54, shown in FIGS. 24 and 25, that is attached at a first end 56 to hinge 35 of sound reflector 32. To store the device 10 when not in use, the sound reflectors 32, 34 are closed onto the base plate 16 and the retainer cable 54 is passed through notches 31a and 31b, shown in FIG. 25, in sound reflectors 32, 34. A second end 58 of the retainer cable 54 includes a hook and loop fastener 60 that engages a hook and loop fastener 52 (FIG. 15) on the outer backside of the retainer cable 54. The retainer cable 54 is wrapped around the mobile optical magnifier 10 and secured in place by engaging hook and loop fastener 60 with hook and loop fastener 52 when not in use, ensuring that the magnifier 10 remains compact and occupies the minimum amount of space for storage and mobility. The retainer cable described in this embodiment can also be implemented in the embodiments shown in FIGS. 26a, 26b, 26c, and 27-30.

In a third embodiment of the present invention, the mobile optical magnifier 10 includes rigid telescoping bellows elements (not illustrated) that, when expanded, maintain the magnifier 10 in an open position, forming a cavity between the optical magnifying lens 14, base plate 16, and walls 22, 24.

In a fourth embodiment of the present invention, shown in FIGS. 26a, 26b, 26c, 27, and 28, the mobile optical magnifier 10 comprises foldable rigid walls that includes a rear panel 62 with hinge 63, a top panel 64, a bottom panel 66, and a front panel 68 with an optical magnifying lens 69. When not in use, the panels fold down into a compact, flat design, as shown in FIGS. 26 a, b.

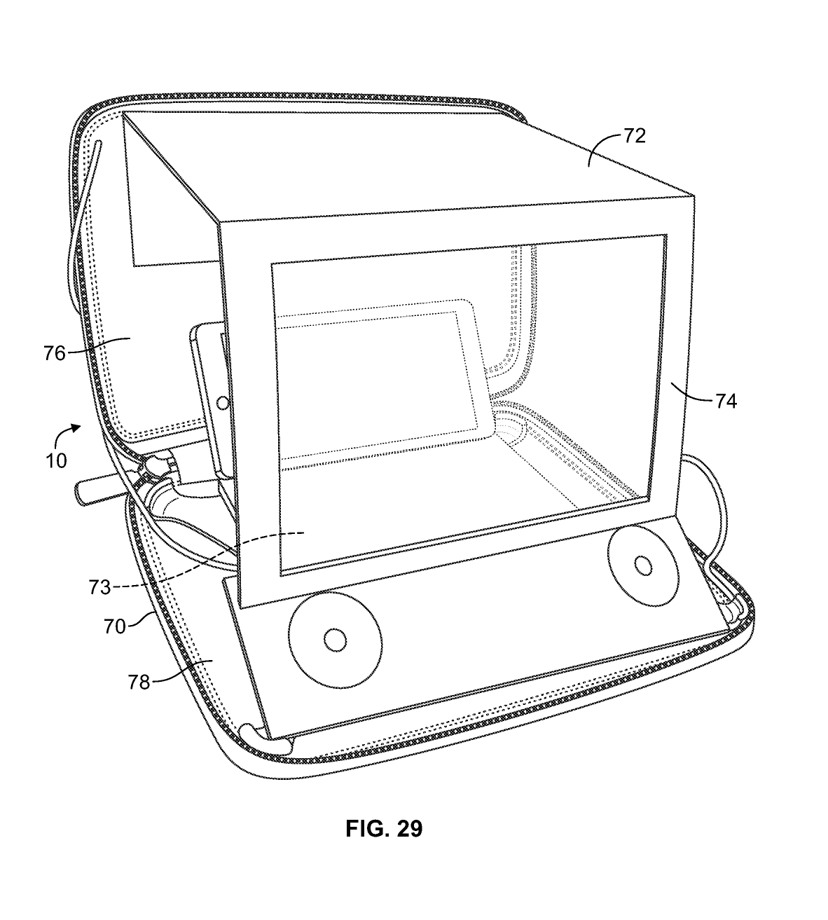

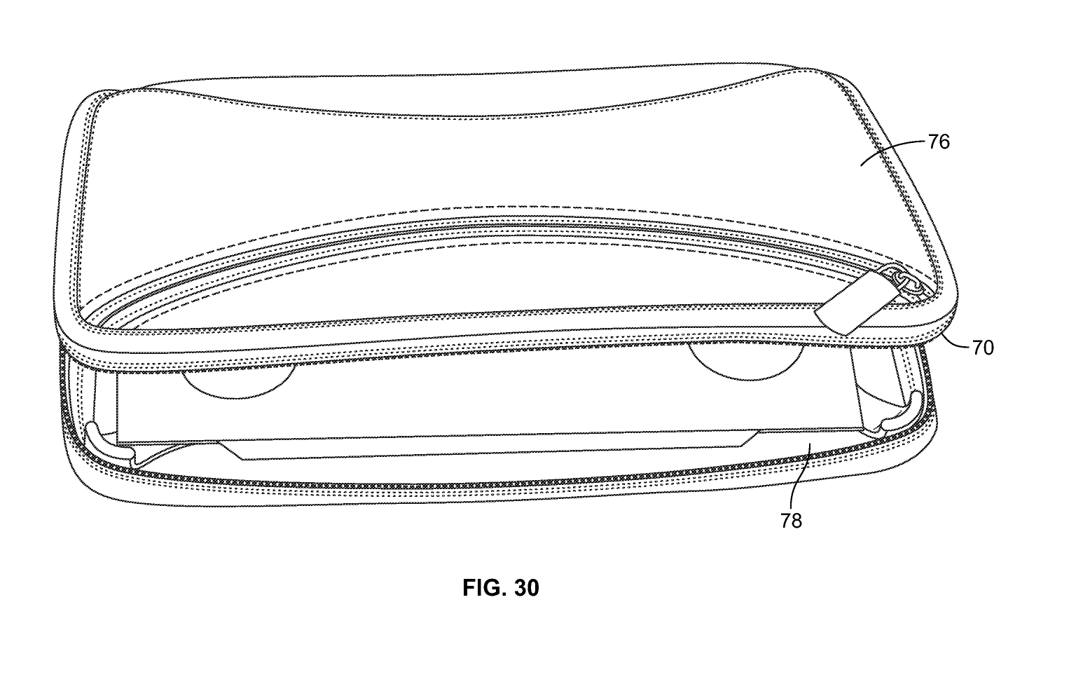

In a fifth embodiment of the present invention, shown in FIGS. 29-30, the mobile optical magnifier 10 includes a zippered pouch 70 that includes a top panel 72, a front panel 74, a bottom panel 78, and a rear panel 76. An optical magnifying lens 73 is disposed within the front panel 74. The top panel 72 is attached to the upper portion of rear panel 76 of the pouch 70, and the front panel 74 is attached to a bottom panel 78 of the pouch 70. When the zippered pouch 70 is opened and the rear panel 76 and bottom panel 78 are set at an angle, the top panel 72, the front panel 74, and the optical magnifying lens 73 are also set at an angle, the angle corresponding to the user's preferred viewing angle.

Optical magnifying lens 14 and 73 in the illustrated embodiments is made of polycarbonate that can be molded to suit the exact optical needs of the mobile optical magnifier. The polycarbonate lens can create a larger virtual screen that has a visual equivalent of watching a 40 inch television screen. Alternatively, the optical magnifying lens 14 and 73 can be a lenticular lens, a Fresnel lens, a lens made of resin, or an optical glass lens. The Fresnel lens, such as a plastic resin Fresnel lens, is lightweight, sturdy, shatterproof, and can provide two to five times magnification. Resin is used to produce lightweight, durable magnifier lenses that provide two to five times magnification. An optical glass lens will provide two to five times magnification depending on the required focal length.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A mobile optical device for magnifying the display screen of a mobile electronic device, the mobile optical device comprising:
a. a wall structure that includes at least one pair of opposing walls;
b. an optical lens mounted on a first end of said wall structure and adjacent said pair of opposing walls; and
c. a base plate mounted on a frame mounted on a second end of said wall structure, said second end opposite said first end, said base plate adjacent said pair of opposing walls and said base plate adapted to support said mobile electronic device.

2. The mobile optical device of claim 1, wherein the at least one pair of opposing walls comprises at least one of collapsible bellows, flexible bellows, rigid telescoping bellows, foldable rigid walls, and soft sided walls adapted to collapse for storage when the mobile optical device is not in use.

3. The mobile optical device of claim 1, wherein said wall structure includes at least one aperture in at least one of said opposing walls, said aperture adapted to be visible and accessible by a user when the at least one pair of opposing walls are fully extended and adapted to allow said user to place the mobile electronic device on said base plate.

4. The mobile optical device of claim 1, further comprising:
a. at least one independently hinged sound reflector having a first hinge and a notch opposite said first hinge, said first hinge adapted to engage a second hinge on said base plate; and
b. said sound reflector adapted to passively redirect and amplify the audio generated by the mobile electronic device.

5. The mobile optical device of claim 1, further comprising a hinged lens cover plate having at least one hinge pivotally connected to the frame, the hinged lens cover plate adapted to cover the optical lens when the mobile optical device is not in use and adapted to adjust the height of the optical lens when the mobile optical device is in use.

6. The mobile optical device of claim 4, further comprising:
a. a retainer cable including a first end and a second end, said first end having a first hook and loop fastener and said second end having a second hook and loop fastener;
b. said first end engaging said first hinge of said sound reflector; and
c. said first end and said second end adapted to pass through the notch in the sound reflector and wrap around said mobile optical device and said first hook and loop fastener adapted to engage said second hook and loop fastener.

7. The mobile optical device of claim 4, further comprising an active cable including a first end engaging said first hinge of said sound reflector, said first end having a standard 3.5 mm jack plug adapted to connect to an audio port on the mobile electronic device, said active cable adapted to control the mobile electronic device.

8. The mobile optical device of claim 7, wherein the active cable includes at least one of at least one speaker and a microphone.

9. The mobile optical device of claim 7, wherein the active cable includes a second end having a control panel.

10. The mobile optical device of claim 9, wherein the control panel includes at least one of an audio control switch, a video control switch, and a call handling switch;
a. said audio control switch adapted to adjust the audio output level of the mobile electronic device;
b. said video control switch adapted to play, pause, rewind, and fast forward a video displayed on the mobile electronic device; and
c. said call handling switch adapted to allow a user to place a call, answer a call, and end a call on the mobile electronic device.

11. The mobile optical device of claim 9, wherein an outer side of the first end of the active cable includes a first hook and loop fastener and the second end of the active cable includes a second hook and loop fastener, said first end and said second end adapted to pass through the notch in the sound reflector and wrap around said mobile optical device and said first hook and loop fastener adapted to engage said second hook and loop fastener.

12. The mobile optical device of claim 5, wherein the hinged lens cover plate includes a first section and a second section pivotally connected through a lateral hinge.

13. The mobile optical device of claim 4, further comprising an active cable including a first end having a plug adapted to connect to a data port on the mobile electronic device, said active cable adapted to control the mobile electronic device.

14. The mobile optical device of claim 13, wherein the active cable includes a second end having a control panel.

15. The mobile optical device of claim 14, wherein the control panel includes at least one of an audio control switch, a video control switch, and a call handling switch;
a. said audio control switch adapted to adjust the audio output level of the mobile electronic device;
b. said video control switch adapted to play, pause, rewind, and fast forward a video displayed on the mobile electronic device; and
c. said call handling switch adapted to allow a user to place a call, answer a call, and end a call on the mobile electronic device.

16. The mobile optical device of claim 9, wherein the control panel includes at least one switch adapted to control play, pause, rewind, and fast forward commands when the mobile electronic device is playing one of audio and video and adapted to control call handling when the mobile electronic device is not playing one of audio and video.

17. The mobile optical device of claim 14, wherein the control panel includes at least one switch adapted to control play, pause, rewind, and fast forward commands when the mobile electronic device is playing one of audio and video and adapted to control call handling when the mobile electronic device is not playing one of audio and video.

18. The mobile optical device of claim 14, wherein an outer side of the first end of the active cable includes a first hook and loop fastener and the second end of the active cable includes a second hook and loop fastener, said first end and said second end adapted to pass through the notch in the sound reflected and wrap around said mobile optical device and said first hook and loop fastener adapted to engage said second hook and loop fastener.

19. The mobile optical device of claim 2, wherein the rigid telescoping bellows form a cavity disposed between the optical lens, the base plate, and the at least one pair of walls when said rigid telescoping bellows are expanded.

20. The mobile optical device of claim 2, wherein the foldable rigid walls include a rear panel having a hinge, a top panel, a bottom panel, and a front panel, said optical lens disposed within said front panel, said rear panel adapted to support said mobile electronic device, and said top panel, bottom panel, and front panel adapted to fold down into a compact, flat design when said mobile optical device is not in use.

21. A mobile optical device for magnifying the display screen of a mobile electronic device, the mobile optical device comprising:
a. a zippered pouch including a top panel, a front panel, a bottom panel and a rear panel, said top panel attached to an upper portion of said rear panel and said front panel attached to a front portion of said bottom panel;
b. an optical lens disposed in said front panel, said front panel attached to a side of said zippered pouch;
c. said rear panel adapted to support said mobile electronic device, said rear panel opposite said front panel; and
d. said top panel and front panel adapted to fold down into a compact, flat design within said rear panel and said bottom panel when said mobile optical device is not in use.

22. The mobile optical device of claim 1, wherein the optical lens is a magnifying lens.

23. The mobile optical device of claim 21, wherein the optical lens is a magnifying lens.

24. The mobile optical device of claim 1, wherein the optical lens is one of a polycarbonate lens, a lenticular lens, a Fresnel lens, a resin lens, and an optical glass lens.

25. The mobile optical device of claim 21, wherein the optical lens is one of a polycarbonate lens, a lenticular lens, a Fresnel lens, a resin lens, and an optical glass lens.

26. The mobile optical device of claim 21, further comprising at least one aperture adapted to be visible and accessible by a user when the zippered pouch is open and adapted to allow said user to place the mobile electronic device on said base plate.

27. The mobile optical device of claim 21, further comprising:
a. at least one independently hinged sound reflector having a first hinge and a notch opposite said first hinge, said first hinge adapted to engage a second hinge on said zippered pouch; and
b. said sound reflector adapted to passively redirect and amplify the audio generated by the mobile electronic device.

28. The mobile optical device of claim 21, further comprising a hinged lens cover plate having at least one hinge pivotally connected to the zippered pouch, the hinged lens cover plate adapted to cover the optical lens when the mobile optical device is not in use and adapted to adjust the height of the optical lens when the mobile optical device is in use.

29. The mobile optical device of claim 27, further comprising:
a. a retainer cable including a first end and a second end, said first end having a first hook and loop fastener and said second end having a second hook and loop fastener;
b. said first end engaging said first hinge of said sound reflector; and
c. said first end and said second end adapted to pass through the notch in the sound reflector and wrap around said mobile optical device and said first hook and loop fastener adapted to engage said second hook and loop fastener.

30. The mobile optical device of claim 27, further comprising an active cable including a first end engaging said first hinge of said sound reflector, said first end having a standard 3.5 mm jack plug adapted to connect to an audio port on the mobile electronic device, said active cable adapted to control the mobile electronic device.

31. The mobile optical device of claim 30, wherein the active cable includes at least one of at least one speaker and a microphone.

32. The mobile optical device of claim 30, wherein the active cable includes a second end having a control panel.

33. The mobile optical device of claim 32, wherein the control panel includes at least one of an audio control switch, a video control switch, and a call handling switch;
a. said audio control switch adapted to adjust the audio output level of the mobile electronic device;
b. said video control switch adapted to play, pause, rewind, and fast forward a video displayed on the mobile electronic device; and
c. said call handling switch adapted to allow a user to place a call, answer a call, and end a call on the mobile electronic device.

34. The mobile optical device of claim 30, wherein an outer side of the first end of the active cable includes a first hook and loop fastener and the second end of the active cable includes a second hook and loop fastener, said first end and said second end adapted to pass through the notch in the sound reflector and wrap around said mobile optical device and said first hook and loop fastener adapted to engage said second hook and loop fastener.

35. The mobile optical device of claim 28, wherein the hinged lens cover plate includes a first section and a second section pivotally connected through a lateral hinge.

36. The mobile optical device of claim 27, further comprising an active cable including a first end having a plug adapted to connect to a data port on the mobile electronic device, said active cable adapted to control the mobile electronic device.

37. The mobile optical device of claim 36, wherein the active cable includes a second end having a control panel.

38. The mobile optical device of claim 37, wherein the control panel includes at least one of an audio control switch, a video control switch, and a call handling switch;
a. said audio control switch adapted to adjust the audio output level of the mobile electronic device;
b. said video control switch adapted to play, pause, rewind, and fast forward a video displayed on the mobile electronic device; and
c. said call handling switch adapted to allow a user to place a call, answer a call, and end a call on the mobile electronic device.

39. The mobile optical device of claim 32, wherein the control panel includes at least one switch adapted to control play, pause, rewind, and fast forward commands when the mobile electronic device is playing one of audio and video and adapted to control call handling when the mobile electronic device is not playing one of audio and video.

40. The mobile optical device of claim 37, wherein the control panel includes at least one switch adapted to control play, pause, rewind, and fast forward commands when the mobile electronic device is playing one of audio and video and adapted to control call handling when the mobile electronic device is not playing one of audio and video.

41. The mobile optical device of claim 37, wherein an outer side of the first end of the active cable includes a first hook and loop fastener and the second end of the active cable includes a second hook and loop fastener, said first end and said second end adapted to pass through the notch in the sound reflected and wrap around said mobile optical device and said first hook and loop fastener adapted to engage said second hook and loop fastener.

42. The mobile optical device of claim 21, further comprising:
a. an active cable including a first end having a standard 3.5 mm jack plug adapted to connect to an audio port on the mobile electronic device, said active cable adapted to control the mobile electronic device;
b. a control panel disposed in one of said front panel, top panel, rear panel, and bottom panel, said control panel including at least one of an audio control switch, a video control switch, and a call handling switch;
c. said audio control switch adapted to adjust the audio output level of the mobile electronic device;
d. said video control switch adapted to play, pause, rewind, and fast forward a video displayed on the mobile electronic device; and
e. said call handling switch adapted to allow a user to place a call, answer a call, and end a call on the mobile electronic device.

43. The mobile optical device of claim 21, further comprising:
a. an active cable including a first end having a plug adapted to connect to a data port on the mobile electronic device, said active cable adapted to control the mobile electronic device;
b. a control panel disposed in one of said front panel, top panel, rear panel, and bottom panel, said control panel including at least one of an audio control switch, a video control switch, and a call handling switch;
c. said audio control switch adapted to adjust the audio output level of the mobile electronic device;
d. said video control switch adapted to play, pause, rewind, and fast forward a video displayed on the mobile electronic device; and
e. said call handling switch adapted to allow a user to place a call, answer a call, and end a call on the mobile electronic device.
